(19) United States
(12) Patent Application Publication
(10) Pub. No.: US 2011/0149416 A1
(43) Pub. Date: Jun. 23, 2011

(54) Imaging Lens

(76) Inventor: Chun-Hong Chen, Taichung (TW)

(21) Appl. No.: 12/972,930

(22) Filed: Dec. 20, 2010

(30) Foreign Application Priority Data
Dec. 23, 2009 (TW) 098144608

(51) Int. Cl. G02B 13/18

(52) U.S. Cl. 359/717

(57) ABSTRACT

An imaging lens includes an aperture stop, and plastic-made meniscus first and second lens elements arranged in the given order from an object side to an image side. Each of the first and second lens elements has an object-side surface and an imaging-side surface facing toward the object side and the image side, respectively. Each of the object-side surface of the first lens element and the imaging-side surface of the second lens element is a convex surface. At least one of the object-side and imaging-side surfaces of each of the first and second lens elements is an aspherical surface. The imaging lens satisfies the optical conditions of: 0.1<f₁/EFL<2, and 0.1<R₁/R₂<2,
wherein f₁ is a focal length of the first lens element, EFL is an effective focal length of the imaging lens, and R₁ and R₂ are radii of curvature of the object-side and imaging-side surfaces of the first lens element, respectively.

### CROSS-REFERENCE TO RELATED APPLICATION

This application claims priority of Taiwanese Application No. 098144608, filed on Dec. 23, 2009.

### BACKGROUND OF THE INVENTION

1. Field of the Invention

The present invention relates to an imaging lens, more particularly to an imaging lens with two lens elements.

2. Description of the Related Art

Imaging lenses with three lens elements are widely adopted for use in electronic devices such as mobile phones and digital cameras. Each of U.S. Pat. Nos. 6,844,989 and 6,985,307 discloses an imaging lens with first, second, and third lens elements, and an aperture stop. The first, second, and third lens elements are arranged from an object side of the imaging lens in the given order, and have a positive refractive index, a positive refractive index, and a negative refractive index, respectively. The aperture stop is disposed between the first and second lens elements.

U.S. Pat. No. 6,927,925 discloses an imaging lens with first, second, and third lens elements, and an aperture stop. The first, second, and third lens elements are arranged from an object side of the imaging lens in the given order, and have a positive refractive index, a negative refractive index, and a positive refractive index, respectively. The aperture stop is disposed between the first and second lens elements.

In the imaging lenses, assembly of the aperture stop is substantially relevant to the first and second lens elements, which may be unfavorable to assembly of the imaging lenses.

Each of U.S. Pat. Nos. 6,992,840 and 7,064,905 discloses an imaging lens with first, second, and third lens elements, and an aperture stop. The first, second, and third lens elements are arranged from an object side of the imaging lens in the given order, and have a positive refractive index, a positive refractive index, and a negative refractive index, respectively. The aperture stop is disposed at the object side.

In some of the above-mentioned imaging lenses, not all of the first, second, and third lens elements have aspherical surfaces. Further, in some of the above-mentioned imaging lenses, the first lens element is made of glass, and the second and third lens elements are made of plastic. While the first lens element may significantly improve image quality, manufacture of the first lens element may be difficult and costs of which may be significantly higher.

### SUMMARY OF THE INVENTION

Therefore, an object of the present invention is provide an imaging lens capable of alleviating the above drawbacks of the aforesaid imaging lenses of the prior art.

Accordingly, an imaging lens of the present invention includes an aperture stop, a first lens element, and a second lens element arranged in the given order from an object side to an image side. Each of the first and second lens elements is a meniscus lens made of plastic, and has an object-side surface facing toward the object side and an imaging-side surface facing toward the image side. Each of the object-side surface of the first lens element and the imaging-side surface of the second lens element is a convex surface. At least one of the object-side and imaging-side surfaces of the first lens element is an aspherical surface. At least one of the object-side and imaging-side surfaces of the second lens element is an aspherical surface. The imaging lens satisfies the optical conditions of:

0.1<f₁/EFL<2, and

0.1<R₁/R₂<2

wherein f₁ is a focal length of the first lens element, EFL is an effective focal length of the imaging lens, and R₁ and R₂ are radii of curvature of the object-side and imaging-side surfaces of the first lens element, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram to illustrate the first preferred embodiment of an imaging lens according to the present invention;

FIG. 2 is a schematic diagram to illustrate optical paths in which light rays that enter the imaging lens of the first preferred embodiment travel;

FIG. 3 is a plot to illustrate field of curvature of the imaging lens of the first preferred embodiment;

FIG. 4 is a plot to illustrate distortion aberration of the imaging lens of the first preferred embodiment;

FIG. 5 is a plot to illustrate modulus of optical transfer function and polychromatic diffraction modulation transfer function at 1 mm units of spatial frequency, the plot corresponding to the imaging lens of the first preferred embodiment;

FIG. 6 is a schematic diagram to illustrate optical paths in which light rays that enter the imaging lens of the second preferred embodiment travel;

FIG. 7 is a plot to illustrate field of curvature of the imaging lens of the second preferred embodiment;

FIG. 8 is a plot to illustrate distortion aberration of the imaging lens of the second preferred embodiment;

FIG. 9 is a plot to illustrate modulus of optical transfer function and polychromatic diffraction modulation transfer function at 1 mm units of spatial frequency, the plot corresponding to the imaging lens of the second preferred embodiment;

FIG. 10 is a schematic diagram to illustrate optical paths in which light rays that enter the imaging lens of the third preferred embodiment travel;

FIG. 11 is a plot to illustrate field of curvature of the imaging lens of the third preferred embodiment;

FIG. 12 is a plot to illustrate distortion aberration of the imaging lens of the third preferred embodiment; and

FIG. 13 is a plot to illustrate modulus of optical transfer function and polychromatic diffraction modulation transfer function at 1 mm units of spatial frequency, the plot corresponding to the imaging lens of the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

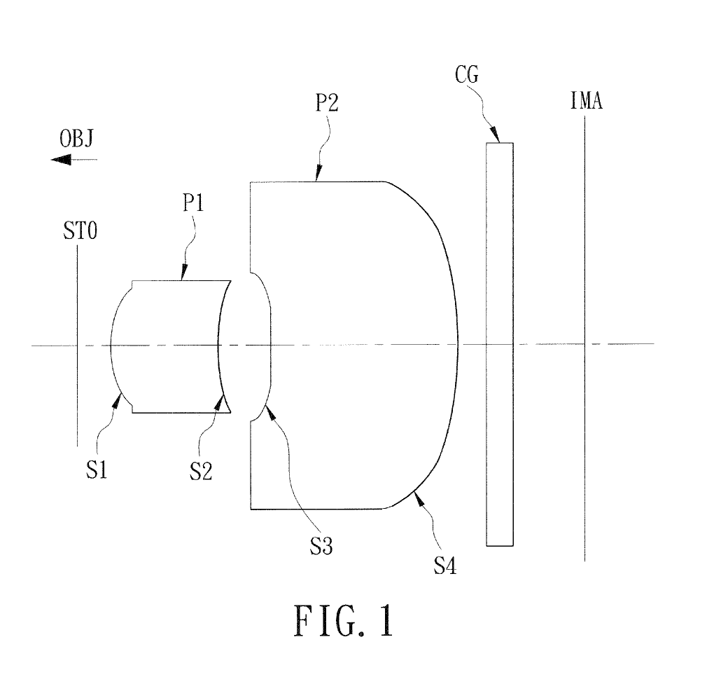

The preferred embodiments of an imaging lens according to the present invention are applicable to electronic devices such as mobile phones and miniaturized digital cameras, and are used with an image sensor, such as a CCD or CMOS image sensor, for capturing images of a target object. Referring to FIG. 1, the imaging lens of each of the preferred embodiments includes an aperture stop (ST0), a first lens element (P1), and a second lens (P2) arranged from an object side (OBJ) to an image side (IMA) in the given order. Refractive power of the imaging lens is substantially determined by the first lens element (P1), while aberration correction of the imaging lens is substantially determined by the second lens element (P2). Such an arrangement of the imaging lens ensures that the imaging lens has a relative short total optical track. Specifically, the first lens element (P1) is a meniscus lens element with a convex object-side surface (S1) facing toward the object side (OBJ) and a concave imaging-side surface (S2) facing toward the image side (IMA). The second lens element (P2) is a meniscus lens element with a concave object-side surface (S3) facing toward the object side (OBJ) and a convex imaging-side surface (S4) facing toward the image side (IMA) Depending on requirements, a flat glass panel (CG) coated with an anti-reflection film or an infrared-filtering film may be disposed between the second lens element (P2) and the image side (IMA). It is to be noted that, by disposing the aperture stop (ST0) between the object side (OBJ) and the first lens element (P1), without altering an incident angle of a chief ray at the same field of view, length of the imaging lens may be effectively shortened, exit pupil position may be lengthened, and the aperture stop (ST0) may be of less relevance to assembly of the first and second lens elements (P1), (P2).

In the preferred embodiments, the first and second lens elements (P1), (P2) are made of plastic, and at least one of the object-side surface (S1), (S3) and the imaging-side surface (S2), (S4) of each of the first and second lens elements (P1), (P2) is an aspherical surface. This may improve aberration correction performance while reducing costs. Preferably, each of the object-side surfaces (S1), (S3) and the imaging-side surfaces (S2), (S4) of each of the first and second lens elements (P1), (P2) is an aspherical surface, and may be defined by the optical equation of

$$z = \frac{c {h}^{2}}{1 + \sqrt{1 - ( k + 1 ) {c}^{2} {h}^{2}}} + A {h}^{4} + B {h}^{6} + C {h}^{8} + D {h}^{10} + E {h}^{12} + F {h}^{14} + G {h}^{16} + H {h}^{18} + I {h}^{20}$$

wherein z represents a position value at a height (h) of a corresponding one of the object-side and imaging-side surfaces with respect to an optical axis of a corresponding one of the first and second lens elements (P1), (P2), c is a reciprocal of a radius of curvature, k represents a conic constant, and A, B, C, D, E, F, G, H, and I are higher-order aspherical surface coefficients. Through the use of aspherical lenses, the total number of lens elements in the imaging lens of this invention is reduced to reduce the total length of the imaging lens accordingly. As for the refractive indices of the first and second lens element (P1), (P2), they may be both positive, or one may be positive and the other may be negative. It is to be noted that configurations of the first and second lens elements (P1), (P2) and the surfaces thereof (S1), (S2), (S3), (S4) are not limited to such. In particular, the first and second lens elements (P1), (P2) may be made of the same plastic material or different plastic materials, and some of the surfaces (S1), (S2), (S3), (S4) may be spherical surfaces. By using plastic as the material for the first and second lens elements (P1), (P2), advantages such as lightweight, impact resistance and ease of forming may be obtained.

The imaging lenses of the preferred embodiments satisfy optical conditions 1 and 2:

0.1<f₁/EFL<2 (1)

0.1<R₁/R₂<2 (2)

wherein f₁ is a focal length of the first lens element (P1), EFL is an effective focal length of the imaging lens, and R₁ and R₂ are radii of curvature of the object-side and imaging-side surfaces (S1), (S2) of the first lens element (P1), respectively. By satisfying the above optical conditions, lower astigmatism, and higher resolution and imaging quality are possible.

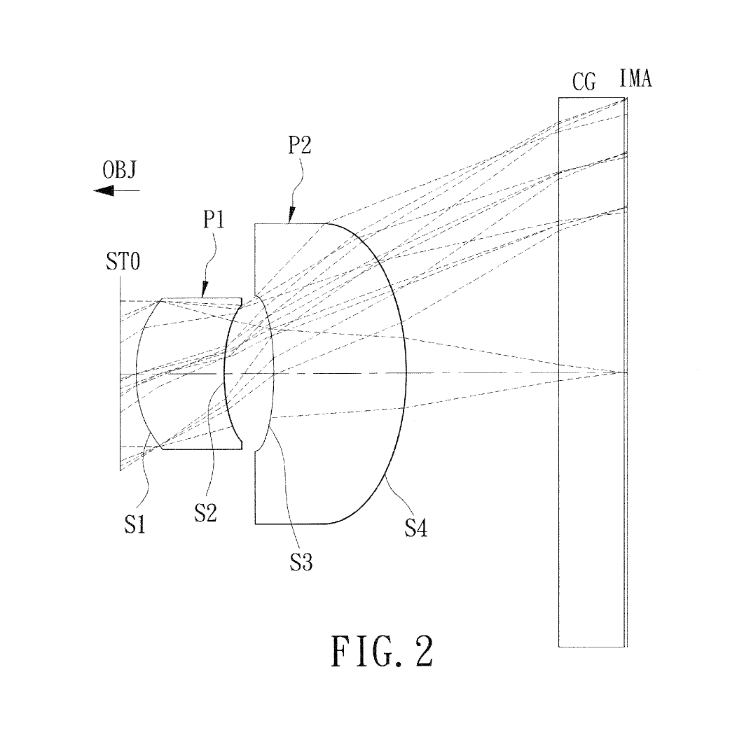

FIG. 2 shows the optical structure of the imaging lens of the first preferred embodiment, and illustrates propagation paths of light rays therethrough. Table 1 shows optical parameters of the imaging lens of the first preferred embodiment, which has an effective focal length (EFL) of 1 mm and is configured to operate at an F-number of 2.8.

TABLE 1

| | Radius of | | | Abbe |
|---|---|---|---|---|
| | Curvature | Thickness | Refractivity | Number |
| | (mm) | (mm) | (N_{d}) | (V_{d}) |
| OBJ | ∞ | — | — | — |
| ST0 | ∞ | 0.06601 | — | — |
| S1 | 0.2895 | 0.2105 | 1.5825 | 30.1821 |
| S2 | 0.4249 | 0.1191 | | |
| S3 | −0.9537 | 0.3122 | 1.5346 | 56.171 |
| S4 | −0.7801 | 0.3675 | | |
| S5 | ∞ | 0.1543 | 1.5168 | 64.1673 |
| S6 | ∞ | 0.0082 | | |
| S7 | ∞ | −0.0056 | — | — |
| S8 | ∞ | — | | |

In the first preferred embodiment, the first and second lens elements (P1), (P2) have positive refractive indices and are made of different plastic materials.

The first lens element (P1) has a focal length f₁ of 0.992, which can be obtained through calculations with values of relevant parameters in Table 1. Thus, the value of f₁/EFL is approximately equal to 0.9920, which falls within the range between 0.1 and 2. Subsequently, the value of R₁/R₂ is approximately equal to 0.6813, which falls within the range of 0.1 and 2. Therefore, the imaging lens satisfies optical conditions 1 and 2.

Tables 2-1, 2-2, and 2-3 show values of the higher-order aspherical surface coefficients of the surfaces (S1), (S2), (S3), (S4) in the first preferred embodiment.

TABLE 2-1

| Surface | k | A | B | C |
|---|---|---|---|---|
| S1 | 1.215754 | −5.6153236 | 46.901226 | −20268.514 |
| S2 | −5.089609 | 15.532112 | −170.64169 | 39732.192 |
| S3 | 24.87456 | −6.9141352 | 751.4939 | −130365.19 |
| S4 | 3.760239 | −0.48014529 | 9.1149542 | −182.27045 |

TABLE 2-2

| Surface | D | E | F |
|---|---|---|---|
| S1 | 1446746.2 | −91139609 | 3.0206e+009 |
| S2 | −2499298.5 | 69461367 | −5.6058e+008 |
| S3 | 9621353.2 | −3.7798e+008 | 7.6028e+009 |
| S4 | 1691.7508 | −8840.6466 | 24262.609 |

TABLE 2-3

| Surface | G | H | I |
|---|---|---|---|
| S1 | −4.0546e+010 | — | — |
| S2 | 9.3666e+008 | — | — |
| S3 | −6.2719e+010 | — | — |
| S4 | −27993.664 | 3244.9534 | −16304.239 |

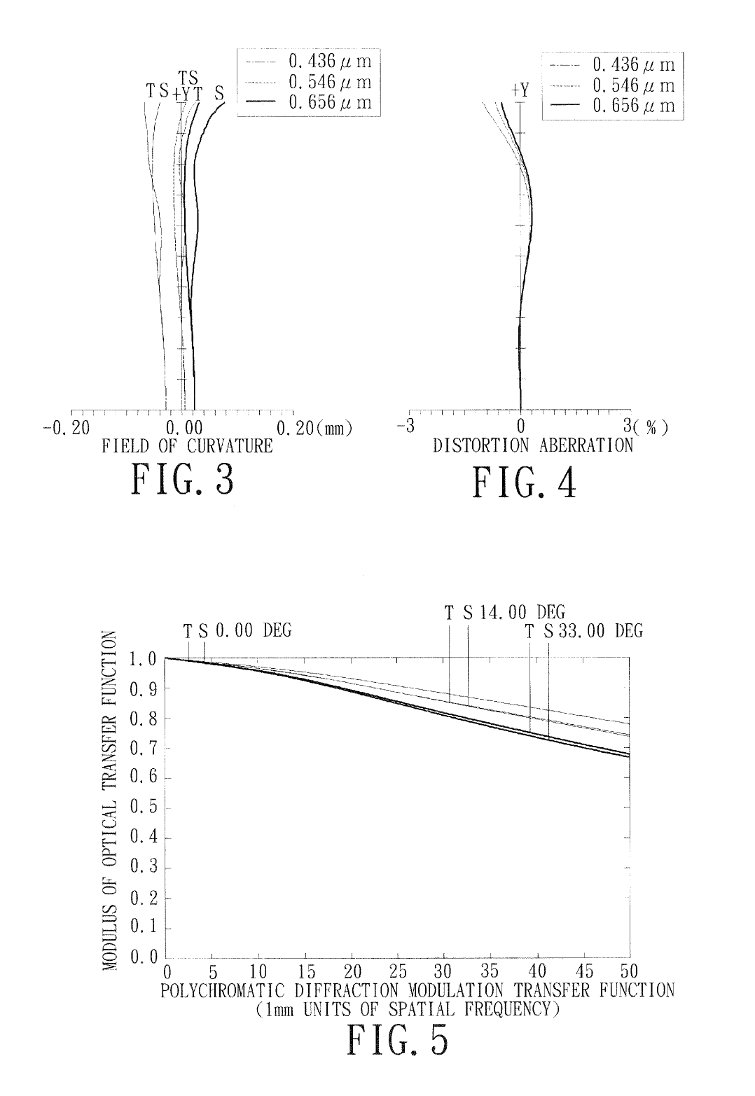

FIGS. 3 and 4 are a plot of field of curvature and a plot of distortion aberration of the first preferred embodiment, respectively. FIG. 5 is a plot illustrating modulus of optical transfer function and polychromatic diffraction modulation transfer function at 1 mm units of spatial frequency.

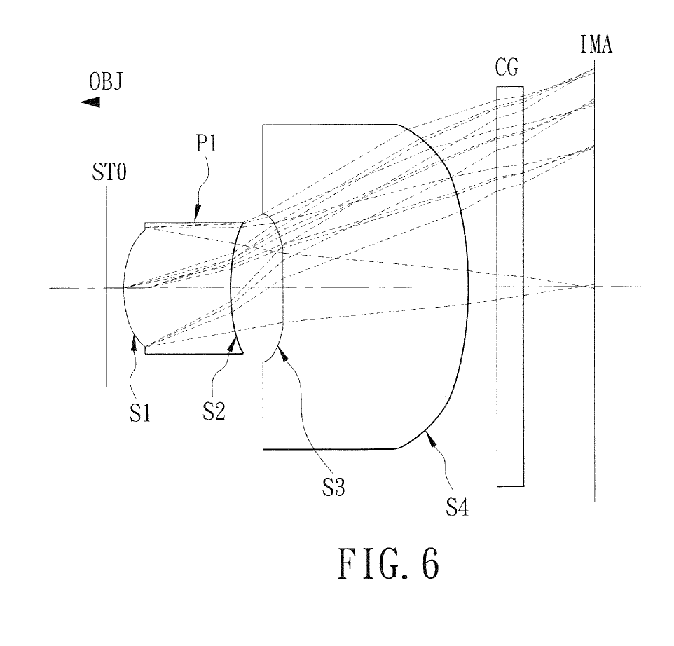

FIG. 6 shows the optical structure of the imaging lens of the second preferred embodiment, and illustrates propagation paths of light rays therethrough. Table 3 shows optical parameters of the imaging lens of the second preferred embodiment, which has an effective focal length (EFL) of 1 mm and is configured to operate at an F-number of 2.8.

TABLE 3

| | Radius of | | | Abbe |
|---|---|---|---|---|
| | Curvature | Thickness | Refractivity | Number |
| | (mm) | (mm) | (N_{d}) | (V_{d}) |
| OBJ | ∞ | ∞ | — | — |
| ST0 | ∞ | 0.06601 | — | — |
| S1 | 0.3344 | 0.2665 | 1.5441 | 56.0936 |
| S2 | 0.7478 | 0.1332 | | |
| S3 | −1.8575 | 0.4584 | 1.5441 | 56.0936 |
| S4 | −2.7109 | 0.0747 | | |
| S5 | ∞ | 0.0672 | 1.6073 | 26.6467 |
| S6 | ∞ | 0.17759 | | |
| S7 | ∞ | 0.0013366 | — | — |
| S8 | ∞ | — | | |

In the second preferred embodiment, the first and second lens elements (P1), (P2) have a positive refractive index and a negative refractive index, respectively, and are made of the same plastic material.

In the second preferred embodiment, the first lens element (P1) has a focal length f₁ of 0.906, which can be obtained through calculations with values of relevant parameters in Table 3. Thus, the value of f₁/EFL is approximately equal to 0.906, which falls within the range between 0.1 and 2. Subsequently, the value of R₁/R₂ is approximately equal to 0.4472, which falls within the range of 0.1 and 2. Therefore, the imaging lens satisfies optical conditions 1 and 2.

Tables 4-1 and 4-2 show values of the higher-order aspherical surface coefficients of the aspherical surfaces (S1), (S2), (S3), (S4) in the second preferred embodiment.

TABLE 4-1

| | | | | |
|---|---|---|---|---|
| Surface | k | A | B | C |

| | | | | |
|---|---|---|---|---|
| S1 | 0.18147 | 0.140715 | −30.7121 | −608.328 |
| S2 | 4.298406 | −2.19341 | 359.3754 | −15700.8 |
| S3 | −32.2849 | −19.8652 | 1930.013 | −203152 |
| S4 | 13.61482 | −2.28145 | 43.53408 | −992.727 |

TABLE 4-2

| Surface | D | E | F | G |
|---|---|---|---|---|
| S1 | 29710.72 | 0 | 0 | 0 |
| S2 | 266403.2 | −202896 | −791089 | −1.7E+08 |
| S3 | 11384311 | −3.6E+08 | 5.81E+09 | −3.9E+10 |
| S4 | 11235.25 | −70182.3 | 224770.8 | −289790 |

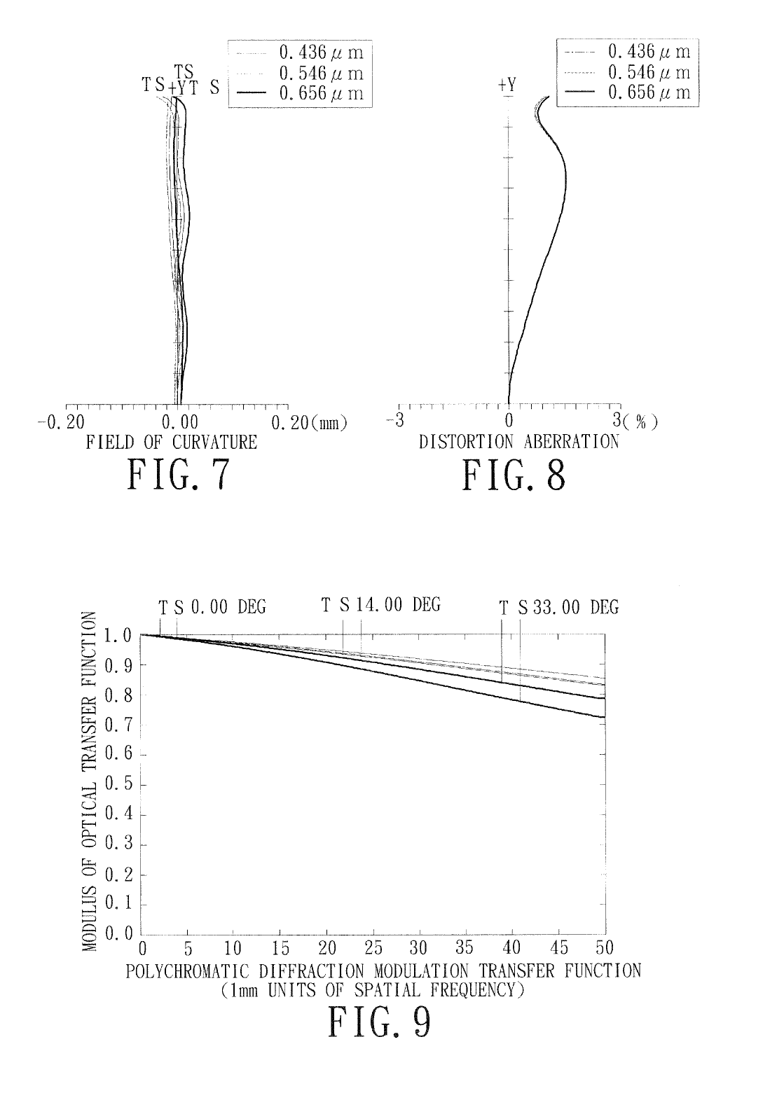

FIGS. 7 and 8 are a plot of field curvature and a plot of distortion aberration of the second preferred embodiment, respectively. FIG. 9 is a plot illustrating modulus of optical transfer function and polychromatic diffraction modulation transfer function at 1 mm units of spatial frequency.

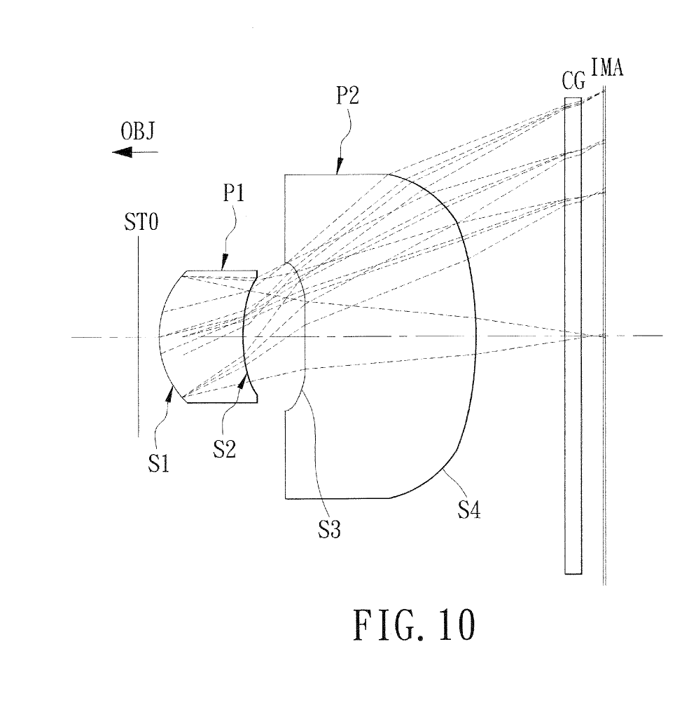

FIG. 10 shows the optical structure of the imaging lens of the third preferred embodiment, and illustrates propagation paths of light rays therethrough. Table 5 shows optical parameters of the imaging lens of the third preferred embodiment, which has an effective focal length (EFL) of 1 mm and is configured to operate at an F-number of 2.8.

TABLE 5

| | Radius of | | | Abbe |
|---|---|---|---|---|
| | Curvature | Thickness | Refractivity | Number |
| | (mm) | (mm) | (N_{d}) | (V_{d}) |
| OBJ | ∞ | ∞ | — | — |
| ST0 | ∞ | 0.032873 | — | — |
| S1 | 0.2966 | 0.2156 | 1.5312 | 56.0438 |
| S2 | 0.5748 | 0.1566 | | |
| S3 | −1.8996 | 0.4416 | 1.5441 | 56.0936 |
| S4 | −2.5811 | 0.2301 | | |
| S5 | ∞ | 0.042735 | 1.6184 | 27.63 |
| S6 | ∞ | 0.056804 | | |
| S7 | ∞ | 0.00513954 | — | — |
| S8 | ∞ | — | | |

In the third preferred embodiment, the first and second lens elements (P1), (P2) have a positive refractive index and a negative refractive index, and are made of different plastic materials, respectively.

In the third preferred embodiment, the first lens element (P1) has a focal length f₁ of 0.9092, which can be obtained through calculations with values of relevant parameters in Table 5. Thus, the value of f₁/EFL is approximately equal to 0.9092, which falls within the range between 0.1 and 2. Subsequently, the value of R₁/R₂ is approximately equal to 0.516, which falls within the range of 0.1 and 2. Therefore, the imaging lens satisfies optical conditions 1 and 2.

Tables 6-1, 6-2, and 6-3 show values of the higher-order aspherical surface coefficients of the aspherical surfaces (S1), (S2), (S3), (S4) in the third preferred embodiment.

TABLE 6-1

| Surface | k | A | B | C |
|---|---|---|---|---|
| S1 | 0.202274 | −0.78721 | 98.64137 | −4392.84 |
| S2 | 8.104899 | −0.667393 | 29.012727 | −581.2088 |
| S3 | 41.54034 | −4.130274 | 176.64853 | −7825.381 |
| S4 | 27.87367 | −0.578684 | 3.979557 | −37.05969 |

TABLE 6-2

| Surface | D | E | F |
|---|---|---|---|
| S1 | 61902.64 | −34332.7 | 0 |
| S2 | 4644.2925 | −5761.0308 | −129558.84 |
| S3 | 191685.84 | −2628039.2 | 18876996 |
| S4 | 186.28755 | −515.94809 | 731.27195 |

TABLE 6-3

| Surface | G | H | I |
|---|---|---|---|
| S1 | 0 | — | — |
| S2 | −2496478.2 | 97871988 | −8.52e+008 |
| S3 | −56717007 | −3319567.6 | 1.092e+008 |
| S4 | −418.37676 | 4.2322336 | −15.265263 |

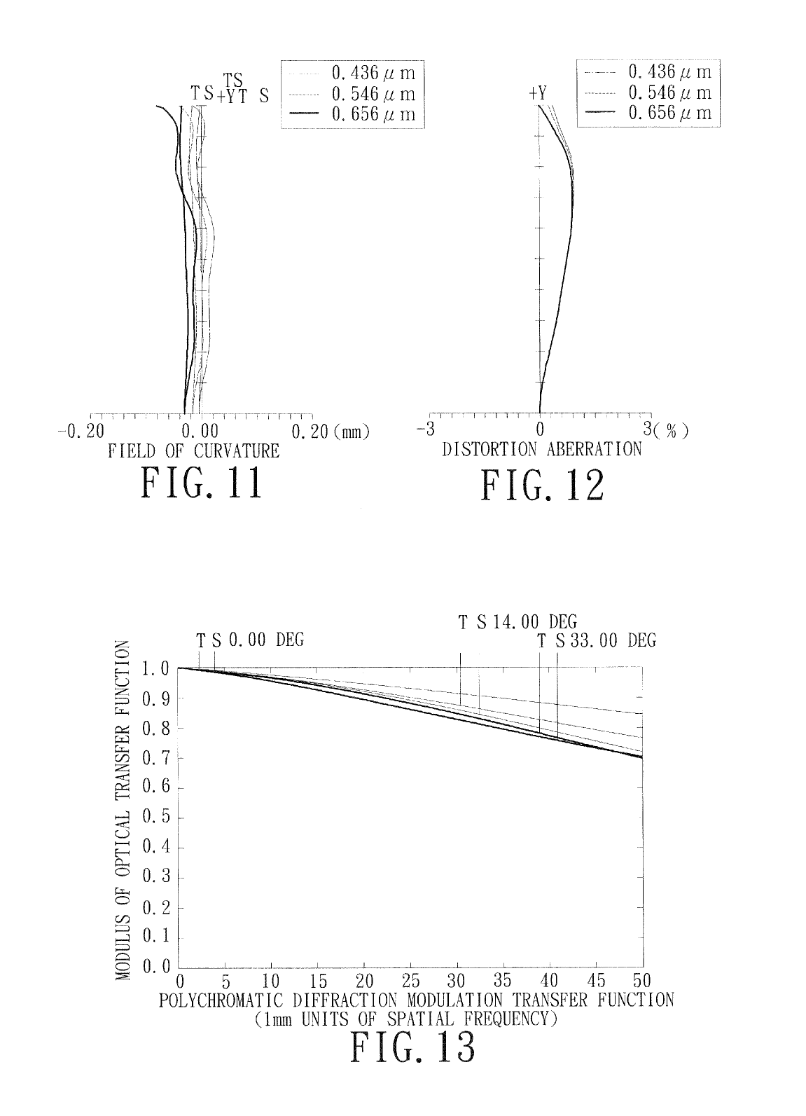

FIGS. 11 and 12 are a plot of field curvature and a plot of distortion aberration of the third preferred embodiment, respectively. FIG. 13 is a plot illustrating modulus of optical transfer function and polychromatic diffraction modulation transfer function at 1 mm units of spatial frequency.

In summary, the imaging lens of each of the preferred embodiments has relatively lower costs and weight, and a relatively shorter physical length, and is relatively easy to assemble. Moreover, the first and second lens elements (P1), (P2) may be made of the same plastic material or of different plastic materials.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An imaging lens comprising an aperture stop, a first lens element, and a second lens element arranged in the given order from an object side to an image side, each of said first and second lens elements being a meniscus lens made of plastic, and having an object-side surface facing toward the object side and an imaging-side surface facing toward the image side, each of said object-side surface of said first lens element and said imaging-side surface of said second lens element being a convex surface, at least one of said object-side and imaging-side surfaces of said first lens element being an aspherical surface, at least one of said object-side and imaging-side surfaces of said second lens element being an aspherical surface, said imaging lens satisfying the optical conditions of:
0.1<f₁/EFL<2, and
0.1<R₁/R₂<2
wherein f₁ is a focal length of said first lens element, EFL is an effective focal length of said imaging lens, and R₁ and R₂ are radii of curvature of said object-side and imaging-side surfaces of said first lens element, respectively.

2. The imaging lens as claimed in claim 1, wherein said aperture stop is disposed between the object side and said first lens element.

3. The imaging lens as claimed in claim 1, wherein each of said first and second lens elements has a positive refractive index.

4. The imaging lens as claimed in claim 1, wherein said first and second lens elements have a positive refractive index and a negative refractive index, respectively.

5. The imaging lens as claimed in claim 1, wherein said object-side and imaging-side surfaces of said first lens element are aspherical surfaces, respectively.

6. The imaging lens as claimed in claim 5, wherein said object-side and imaging-side surfaces of said second lens element are aspherical surfaces, respectively.

7. The imaging lens as claimed in claim 6, wherein each of said object-side and imaging-side surfaces of each of said first and second lens elements satisfies the optical equation of:
$$z = \frac{c {h}^{2}}{1 + \sqrt{1 - ( k + 1 ) {c}^{2} {h}^{2}}} + A {h}^{4} + B {h}^{6} + C {h}^{8} + D {h}^{10} + E {h}^{12} + F {h}^{14} + G {h}^{16} + H {h}^{18} + I {h}^{20}$$
wherein z represents a position value at a height (h) of a corresponding one of said object-side and imaging-side surfaces with respect to an optical axis of a corresponding one of said first and second lens elements, c is a reciprocal of a radius of curvature, k represents a conic constant, and A, B, C, D, E, F, G, H, and I are higher-order aspherical surface coefficients.

8. The imaging lens as claimed in claim 1, wherein said imaging lens is configured to operate at an F-number of 2.8.

9. The imaging lens as claimed in claim 1, wherein said first and second lens elements are made of different plastic materials.

10. The imaging lens as claimed in claim 1, further comprising a flat glass panel disposed between said second lens element and the image side.

11. The imaging lens as claimed in claim 10, wherein said flat glass panel is coated with an anti-reflection film.

12. The imaging lens as claimed in claim 10, wherein said flat glass panel is coated with an infrared-filtering film.
